(19) United States
(12) Patent Application Publication
(10) Pub. No.: US 2015/0030849 A1
(43) Pub. Date: Jan. 29, 2015

(54) Smarttouch

(71) Applicant: Brandon Lee Finlen, Lorton, VA (US)

(72) Inventor: Brandon Lee Finlen, Lorton, VA (US)

(21) Appl. No.: 13/987,472

(22) Filed: Jul. 29, 2013

(51) Int. Cl. G06F 3/044

(52) U.S. Cl. CPC G06F 3/044
USPC 428/354

(57) ABSTRACT

This invention covers an adhesive smart device conducive patch that consists of at least an initial layer of structural film, at least one adhesive coating, and a surface of conducive material.

### BRIEF DESCRIPTION OF THE INVENTION

The primary objective of the invention is achieved through an adhesive smart device conducive patch consisting of at least one initial layer of structural film, at least one adhesive coating and a surface of conducive material.

This invention offers as advantages the fact that it results in an adhesive smart device conducive patch that can be affixed to non-smart device conducive items such as gloves, which would allow them to be used on smart devices.

### BRIEF DESCRIPTION OF THE DRAWINGS

This invention will be described in greater detail below, based on an example produced and represented in the drawings. The Figures show:

FIG. 1—an initial view in perspective of the smart device conducive patch product covered by this invention, showing the conducive layer and the adhesive backing and the dimensions for the product.

FIG. 2—a side view of the product covered by the invention, showing width of the product

### DETAILED DESCRIPTION OF THE FIGURES

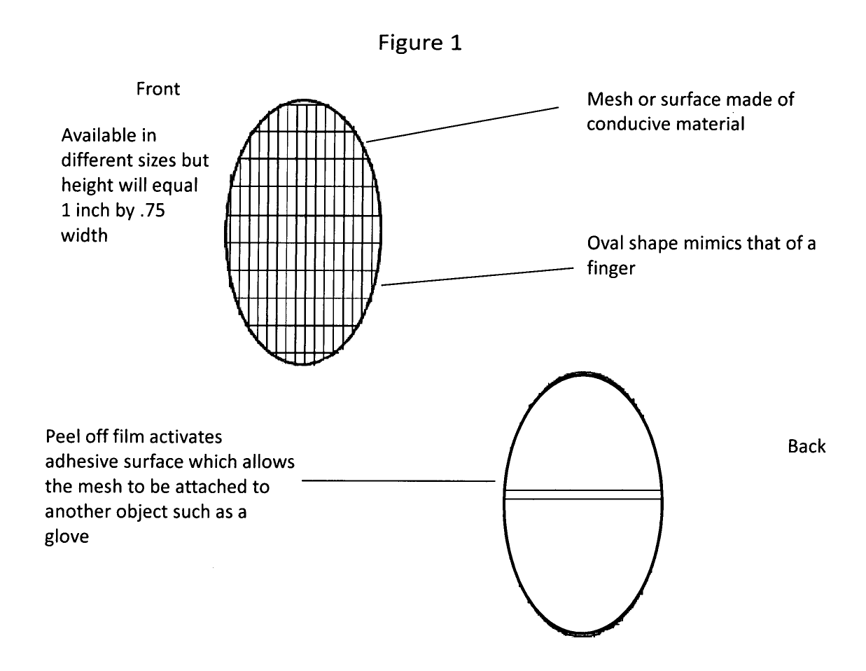

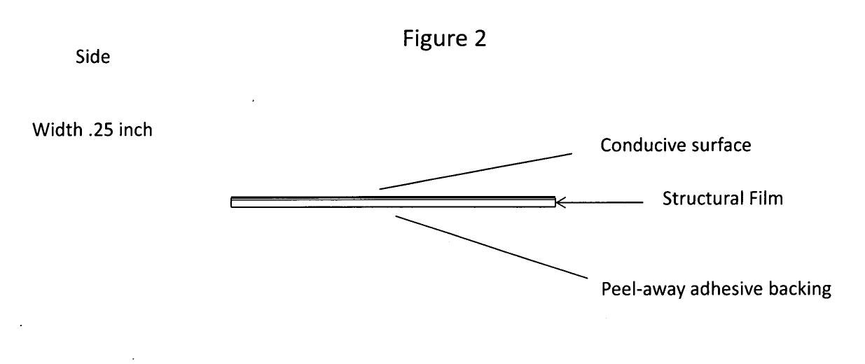

As may be seen in FIGS. 1-2, smart device conducive patch covered by this invention consists essentially of at least an initial layer of structural film 1, at least one adhesive coating 2, and a surface of conducive material the product 1 may take various shapes, such as the preferential format, substantially oval, the circular or square formats, or any other shape that may be necessary and/or desirable.

Preferably, film 1 consists of polyethylene (PE) although this may consist of any other desired polymer, such as polypropylene (PP), vinyl polychloride, foamed polyurethane, non-foamed polyester, combinations thereof and others.

Film 1 serves as a support layer for handling by the user, and as a support for the additional layers of the smart device conducive patch product. It should be flexible enough to allow the application of the smart device conducive patch product easily and to adapt to the shape of the object it is being applied to.

The initial surface of the structural film 1 is associated with at least one adhesive coating 2, preferably in the form of an adhesive layer that covers its entire area. Obviously, the adhesive 2 coating used may be of any type whatsoever, in addition to its specific constitution. As an alternative, for instance, an adhesive coating 2 may be planned to consist of many lines of adhesive, or any other possible situation.

Smart device conducive patch product also consists of at least one surface of smart device conducive material or any other equivalent elements whose function is to transfer conducive properties to objects.

The smart device conducive patch consists preferably of a nylon-fiber mesh, but it is clear that its composition may be any other, provided that this is functional in its smart device conductivity. The smart device conductive patch may be made through a variety of manufacturing processes, such as spun lace, spun bonding, needle punch, etc.

Smart device conducive patch may be any shape, provided that it is functional. In the preferential example of this invention, product is largely oval in shape.

The main innovation of the Smart device conducive patch covered by this invention, which endows it with countless advantages as will be described below, lies in the fact that, in contrast to the uses currently known and used this product can be applied easily to a number of surfaces and objects with minimal effort.

The dimensions of the Smart device conducive patch product is designed for a maximum surface area without becoming unwieldy. The fact that the entire smart device conducive area is in contact with the rest of the film means that the adhesive portion of the product is used to create a secure bond to the object in question. While the dimensions presented in both area and height present an optimal surface area and size it is clear that a smart device conducive patch may be designed whose area and/or height may be greater than that of the corresponding area and thickness presented within this drawing. Consequently the smart device conducive patch may have any shape provided that it is functional.

The adhesive properties of the smart device conducive patch allows for the creation of smart device conductive properties among non-conducive objects with minimal time and effort.

1. Smart device conducive patch product characterized by the fact that it consists of:
At least an initial layer of structural film;
At least one adhesive coating associated with the initial layer of structural film; and
At least one surface of conducive material;
